(19) United States
(12) Patent Application Publication
(10) Pub. No.: US 2009/0285963 A1
(43) Pub. Date: Nov. 19, 2009

(54) FREE-FLOWING GELATIN COMPOSITION

(75) Inventors: Eberhard Dick, Neckargemuend (DE); Simone Walter, Wald-Michelbach (DE)

Correspondence Address: LEYDIG VOIT & MAYER, LTD, 700 THIRTEENTH ST. NW, SUITE 300, WASHINGTON, DC, 20005-3960, US

(73) Assignee: GELITA AG, Eberbach (DE)

(21) Appl. No.: 12/512,074

(22) Filed: Jul. 30, 2009

Related U.S. Application Data
(63) Continuation of application No. PCT/EP2008/000907, filed on Feb. 6, 2008.

(30) Foreign Application Priority Data
Feb. 7, 2007 (DE) 10 2007 007 307.2

(51) Int. Cl. A23L 1/0562

(52) U.S. Cl. 426/576

(57) ABSTRACT

In order to provide a novel free-flowing gelatin composition, in particular for use as food precursor, which gelatin composition retains its flowability, in particular even at temperatures below 30° C., it is proposed that the free-flowing gelatin composition comprises an aqueous liquid, gelatin gel particles dispersed therein and/or dissolved gelatin hydrolysate and one or more sugar components, wherein the sum of the contents of gelatin, gelatin hydrolysate and sugar components(s) is selected such that the water activity (aw value) of the composition is less than or equal to 0.97.

### BACKGROUND OF THE INVENTION

The invention relates to a novel free-flowing gelatin composition, in particular for use as a food precursor. The novel free-flowing gelatin composition retains its flowability in particular even at temperatures below 30° C., for example at 25° C.

The industrial processing of gelatin, particularly in the food industry, utilizes in particular the gel-forming properties of dissolved gelatin in the manufacture of food products. Traditionally, for this purpose gelatin in a dry state, in particular in powder form, is used as an initial product, which is dissolved while adding water and heating. A joint dissolving of gelatin with any further ingredients is as a rule hardly possible since, because of the competition for available water, the gelatin fraction can scarcely be dissolved. For this reason, first a solution of the gelatin fraction is produced and then the solution is mixed with the remaining components of the food product before then allowing this to gel as it cools.

In view of the fact that gelatin, especially in powder form, does not have a particularly highly pronounced wettability and does not dissolve in cold water, its mixing with water and conversion to liquid form are a laborious part of the manufacturing process. This is connected in particular also to the fact that the gelatin particles when stirred into liquids readily stick together and form lumps, thereby slowing down the uniform swelling of the gelatin particles into gelatin gel particles and their dissolving in the liquid.

Excessive agitation to prevent lump formation, on the other hand, may lead to intensive foaming, which has equally an extremely disruptive effect on the production process.

This so-called instant gelatin is admittedly cold soluble and may be processed directly mixed with all the ingredients without previously having to dissolve this special gelatin separately. However, with such gelatin products it is not possible to produce genuine gels but merely gel-like structures that, given identical dosing, possess very much lower gel strengths than a gel manufactured conventionally from a comparable powder gelatin.

A further restriction on the usability of instant gelatin is the many times greater risk of lump formation compared to powder gelatin, for which reason for many applications the use of instant gelatin as an alternative to powder gelatin is not possible.

A certain remedy is found by mixing sugar-containing carrier materials or gelatin hydrolysate with the instant gelatin, wherein the sugar-containing carrier materials and/or the gelatin hydrolysate is used to agglomerate the gelatin particles of the gelatin powder. When the agglomerated particles are stirred into liquids, the carrier materials and/or the gelatin hydrolysate dissolve faster than the gelatin particles themselves and then leave the latter behind, finely distributed in the liquid. The carrier materials and/or the gelatin hydrolysate moreover facilitate the initial wetting. The problem of the reduced gel strength however cannot be solved in this way, unless the mixture as a whole is heated beyond the melting point of the gelatin in order thereby to produce a genuine solution.

Because of the laborious manufacturing process such instant gelatin products are more expensive than powder gelatin, and this, particularly in the case of cost-sensitive food products, has an adverse effect on the cost situation.

### BRIEF SUMMARY OF THE INVENTION

The object of the present invention is to propose an economical gelatin product that is capable of simplified industrial further processing.

This object is achieved by a novel free-flowing gelatin composition, which comprises an aqueous liquid with gelatin particles dispersed therein and/or with gelatin hydrolysate dissolved therein as well as a sugar component, wherein the sum of the contents of gelatin, gelatin hydrolysate and sugar component is selected such that the water activity (aw value) of the composition is less than or equal to 0.97.

### DETAILED DESCRIPTION OF THE INVENTION

The industrial-scale processing of gelatin that is obtained in a drying process from an aqueous solution generally entails, as a first processing step, renewed dissolving of these dry products. It would therefore be advantageous to avoid this renewed dissolving and supply gelatin or gelatin hydrolysates directly without drying to the users. However, apart from only very short interim storage periods, pure gelatin and gelatin hydrolysates are stable in storage only in the dry state. For this reason, at least according to the present state of the art these products directly after their manufacture, when they are still in liquid form, have to be dried immediately in order to render them stable in storage and transportable.

The reasons why storage in liquid form and/or transportation at temperatures below 30° C. is impossible are on the one hand the low microbiological stability of such solutions and on the other hand, in the case of gelatin, the fact that gelatin at these temperatures takes the form of a solid gel. Higher storage temperatures, which both minimize the risk of spoilage and prevent the gelling of gelatin, do not offer a solution because under these conditions massive thermal damage occurs, which renders the product unsuitable for further use, with the result that this alternative also may be used at most for short-term interim storage.

A further alternative, at least for gelatin hydrolysates that are still liquid even at temperatures below 30° C., would naturally be the use of preservatives. The use of such substances is not without problems globally from the point of view of food regulations and is considered unacceptable by many users.

The free-flowing gelatin compositions according to the invention may be transported in tanker lorries without difficulty, often without these having to be heated, and surprisingly also present the required microbiological stability for transportation and storage, this being achieved in particular by selecting the sum of the contents of gelatin, gelatin hydrolysate and sugar component such that the water activity of the composition is less than or equal to 0.97.

A water activity less than or equal to 0.97 means that the water vapour partial pressure at the surface of the free-flowing gelatin composition is less than or equal to 0.97 times the water vapour partial pressure that arises directly above the surface of pure water.

The microbiological stability of the free-flowing gelatin composition thereby achieved is adequate for manufacture, storage, transportation and stockpiling by the industrial user.

Because of the ability of gelatin to absorb water to a large extent, it is in practice impossible to achieve a water activity less than or equal to 0.97 by the dosing of the gelatin particles in the aqueous solution alone. In the present case, the addition of one or more sugar components is an ideal solution to the problem because sugar components are themselves often contained in food recipes and the content already supplied in the free-flowing gelatin composition may easily be taken into consideration by the industrial user during formulation in the course of further processing.

The novel free-flowing gelatin composition according to the invention may easily be further processed in the industrial process as the free-flowing composition need merely be heated in order to melt the gelatin particles dispersed therein completely and hence bring the gelatin into solution. During cooling solid gel structures, such as are customary from the processing of conventional powder gelatin, are then obtained.

In the case of the exclusive use of gelatin hydrolysate, heating is not necessary because it already forms a molecularly disperse, homogeneous mixture with the other components of the composition according to the invention.

The gelatin hydrolysate content is not limited to a soluble fraction. Rather, within the scope of the invention it is possible also to cite compositions, in which dissolved and undissolved gelatin hydrolysate are present alongside one another. The undissolved fractions of gelatin hydrolysate are then present preferably dispersed in the composition according to the invention.

According to the invention, saccharides, in particular mono-, di- and oligosaccharides, in particular sucrose, glucose, fructose, glucose syrups, oligofructose syrups, dextrins and the like are suitable as sugar components.

Further suitable sugar components are sugar substitutes, in particular alditols, such as for example glycerine, threitol, mannitol, isomalt, lactitol, sorbitol, xylitol, erythritol, arabitol and maltitol, as well as polydextrose.

The previously cited sugar components may be used individually or in any combination in the composition according to the invention.

A further advantage of the use of the composition according to the invention is simplified handling because the relatively high outlay when manufacturing in particular highly concentrated gelatin solutions is eliminated.

Gelatin in the form of gelatin gel particles and gelatin hydrolysate may be used alongside one another in any combination in the free-flowing gelatin composition, wherein the gelatin as well as the gelatin hydrolysate may be exclusively present in the composition.

The free-flowing gelatin composition according to the invention is particularly economical to manufacture because the operation of drying to a water content of 10 wt. % that is necessary when manufacturing gelatin powder or gelatin hydrolysate powder may be omitted. In particular, in the case of the gelatin component, it is possible to start from an intermediate product of gelatin manufacture, the so-called gelatin noodles, which contain ca. 30 wt. % dry gelatin substance and ca. 70 wt. % water. These gelatin noodles may easily be chopped by a cutting mechanism (cutter) under cooling conditions (temperature below 20° C.) to produce sufficiently fine gelatin gel particles.

These gelatin particles may be mixed with the sugar component and optionally the desired gelatin hydrolysate fraction, thereby resulting in a free-flowing dispersion of the gelatin gel particles in a liquid matrix that is pumpable and hence may be used in an easily dosable manner in the industrial process.

At the same time, gelatin gel particles may also be mixed directly with the sugar component in solid form, wherein a pumpable dispersion arises already during the mixing operation since because of osmotic effects some of the water bound in the gelatin gel particles escapes and is available to dissolve the sugar component.

Given the water activity of less than or equal to 0.97 that is defined according to the invention, at temperatures of ca. 20° C. a microbiological stability remains guaranteed for at least 2 to 3 weeks, provided that the conventional hygienic conditions of gelatin manufacture are observed.

All the customer or processor has to do is add the dosed further recipe ingredients to the free-flowing gelatin composition and mix them with the free-flowing composition, wherein this mixture may then pass through an, in any case, necessary cooking system in order to obtain a gelling pouring solution for the food product for example, in particular for gumdrops or jelly babies.

In terms of manufacture, the free-flowing gelatin composition according to the invention therefore eliminates not only a drying step but also the interim storage of the product prior to the drying step for further laboratory tests and the grinding and mixing as well as the packing of the gelatin powder. The—compared to this—additional cost of chopping the gelatin noodles, mixing for example with sugar and glucose syrup and the extra cost of transportation are therefore easily justifiable.

For the processor, the complete step of swelling and dissolving the gelatin is eliminated, and the dosing and mixing of the free-flowing gelatin composition according to the invention with the remaining recipe ingredients is simplified. This offers the processor economies not only in terms of equipment but also in terms of personnel costs because, unlike gelatin in powder form, processing of the free-flowing gelatin composition according to the invention may take place fully automatically without any problems.

Furthermore, processors who process powder gelatin often in batch processes that require complicated supply- and weighing systems may use a continuously operating system, which may easily be set up in existing installations by appropriate refitting.

A more extensive microbial stabilization may be achieved by lowering the pH value, for example to values lower than 5, in particular ca. 3 to 4.5, wherein for this purpose preferably edible acids may be used. The aw value remains substantially unaffected by this.

If an even longer microbiological stability of the gelatin composition according to the invention is required, it is recommended that the water activity of the composition be lowered to 0.93 or less. The formulation, i.e. the fractions of gelatin gel particles and/or dissolved gelatin hydrolysate, on the one hand, and sugar component, on the other hand, has to be adapted accordingly.

If gelatin gel particles are used as the sole gelatin ingredient in the free-flowing gelatin composition, the gelatin gel particle content (expressed as dry mass with a water content of ca. 10 wt. %) may vary within the range of 20 to 40 wt. %, in relation to the total weight of the composition.

Higher concentrations of gelatin or, in other words, water contents of 50 wt. % or less (in the case of gelatin hydrolysate-based compositions 35 wt % or less) are on the one hand technically realizable only with difficulty and moreover result in viscosities that extremely limit the pumpability.

Given predominant or exclusive use of gelatin hydrolysate as the gelatin ingredient in the liquid gelatin composition, its content may be varied without difficulty within the range of 20 to 60 wt. %.

The mean molecular weight of the gelatin hydrolysate is preferably selected within the range of ca. 1,000 to ca. 20,000 Da.

The gelatin gel particles in the swollen state (i.e. with a maximum water content) preferably have a mean particle size of ca. 0.01 to 3 mm, in particular 0.1 to 1 mm.

Since, given the use of gelatin hydrolysate as the gelatin component in the composition according to the invention, higher whole protein contents are possible, the sugar component content in such compositions need not be set as high as is the case for compositions with gelatin gel particles as the main gelatin component. Here, sugar component contents of ca. 10 wt. % or more may already bring about adequate microbiological stabilization.

For the compositions according to the invention gelatin hydrolysates may be used in the form of solutions, such as are currently already being used in the manufacture of hydrolysate powder by the spray drying process.

The sugar component, optionally edible acids and, depending on the client's requirements, any further recipe ingredients are added to these solutions. The requisite mixing and dissolving steps may be carried out within a broad temperature range.

Typically representative of the sugar components of the gelatin composition that are used according to the invention are—as already mentioned—saccharides, which in a recipe that is geared mainly to gelatin gel particles as the gelatin component are used preferably in a quantity of 30 wt. % or more, in relation to the total composition.

The saccharides are preferably selected from mono-, di- and/or oligosaccharides, wherein in particular mono- and disaccharides are used, in compositions that are intended as food precursors.

If the gelatin composition according to the invention is to be used in recipes that contain no saccharides, possible alternatives are the above-mentioned sugar substitutes, in particular alditols, such as for example glycerine or other sugar alcohols, oligofructose syrups, polydextrose and dextrins, in particular wheat dextrin.

Such compositions are suitable in particular for the manufacture of dietetic low-sugar products, in particular for the manufacture of low-sugar gumdrops.

As regards the pumpability of the free-flowing gelatin composition according to the invention, it is preferred if the composition has a viscosity of at most ca. 20,000 cP, more preferably at most 10,000 cP. However, even compositions having viscosities of ca. 100,000 cP are free-flowing and may be processed, pumped and proportioned using conventional food technology equipment.

These and further advantages of the invention are described in more detail below by way of the examples.

Where in the following examples swollen gelatin gel particles are used, these originate from an intermediate step of gelatin production, in which so-called gelatin noodles with a water content of ca. 70 wt. % arise. These noodles have been chopped, as described further above, in a so-called cutter to the particle sizes indicated in the individual examples.

### Example 1

### Gelatin Dispersion

### Example A

| | |
|---|---|
| 61.4 wt. % | swollen gelatin gel particles (dry substance ca. 30 wt. %) |
| | mean particle size 0.4 mm; Bloom = 260; gelatin type A |
| 28.0 wt. % | sucrose |
| 10.60 wt/% | glucose syrup (78 wt. %) |

The recipe ingredients may be mixed with one another without adding water and produce a free-flowing composition according to the invention with a water content of ca. 43.4 wt. %. The aw value is 0.97.

At 20° C. this gelatin composition according to the invention has a viscosity of ca. 2500 cP.

### Example B

| | |
|---|---|
| 60.00 wt. % | swollen gelatin gel particles (dry substance ca. 30 wt. %), |
| | mean particle size 0.4 mm; Bloom = 280; gelatin type A |
| 40.00 wt. % | sucrose |

The recipe ingredients may be mixed with one another without adding water and produce a free-flowing composition according to the invention with a water content of ca. 42 wt. %. The aw value is 0.963.

At 20° C. this gelatin composition according to the invention has a viscosity of ca. 14000 cP.

It is suitable in particular as a food precursor for the manufacture of jelly babies or gumdrops.

The processor needs to add to the gelatin composition according to the invention only glucose syrup, sucrose and flavourings as well as optionally colourings and pass this mixture through a cooking system in order easily to obtain a finished pouring solution that may be poured into conventional moulds.

### Example 2

### Gelatin Dispersion Sugar-Free

| | |
|---|---|
| 50 wt. % | swollen gelatin gel particles (dry substance ca. 30 wt. %), |
| | mean particle size 0.3 mm, Bloom = 240; gelatin type A |
| 25 wt. % | wheat dextrin (obtainable as Nutriose ® from Roquette |
| | Frères, France) |
| 25 wt. % | polydextrose |

The water content of this recipe is ca. 36.5 wt %, the aw value is 0.95.

At 20° C. this gelatin composition according to the invention has a viscosity of ca. 6000 cP.

It is suitable in particular as a precursor for the manufacture of low-sugar and/or sugar-free confectionery.

### Example 3

### Liquid Hydrolysate

| | |
|---|---|
| 40 wt. % | gelatin hydrolysate (dry substance), mean molecular |
| | weight = 3000 Da |
| 16 wt. % | sucrose |
| [1 wt. % | citric acid for lowering the pH to ca. pH 4.5; optional] |
| the remainder | water |

The aw value is 0.942.

At 20° C. this gelatin composition according to the invention has a viscosity of ca. 1120 cP.

This gelatin composition according to the invention is likewise usable as a food precursor, for example for the manufacture of protein-enriched gumdrops or the manufacture of edible bars.

It is self-evident that the recipes of Examples 1 to 3 may be modified in such a way that the gelatin content is formed partially by gelatin hydrolysate (Examples 1 and 2) and/or by gelatin gel particles (Example 3).

If in Example 1 gelatin hydrolysate is additionally used, the result is already a precursor for the manufacture of protein-enriched food, for example gumdrops or marshmallows.

The following Tables 1 and 2 demonstrate how with differing contents of the components of the composition according to the invention it is easily possible to adjust the required aw value.

TABLE 1

| Wt. % gelatin | Wt. % sugar | | |
|---|---|---|---|
| (Bloom = 220; type A) | (sucrose) | Wt. % DS mix | aw value |
| 25.0% | 0.0% | 25.0% | 0.994 |
| 19.2% | 23.1% | 42.3% | 0.970 |
| 24.4% | 25.9% | 50.3% | 0.966 |
| 29.3% | 28.6% | 57.9% | 0.959 |
| 34.7% | 33.3% | 68.0% | 0.932 |

TABLE 2

| Wt. % hydrolysate DS | | | |
|---|---|---|---|
| (MW = 3000 Da) | Wt. % sugar 100 | | |
| starting product | (sucrose) | Wt. % DS mix | aw value |
| 51.5% | 0.0% | 51.5% | 0.972 |
| 42.9% | 18.0% | 60.9% | 0.935 |
| 34.3% | 34.1% | 68.4% | 0.883 |
| 28.6% | 43.3% | 71.9% | 0.848 |
| 25.7% | 49.7% | 75.4% | 0.808 |

From the Tables it is likewise evident that the gelatin composition (mix) according to the invention advantageously comprises very high fractions of dry substance (DS), wherein not only is the advantage of microbiological stability achieved but further processing into the finished product may also be effected in an advantageous manner in terms of energy because only relatively low water contents have to be expelled in the product drying operation.

### Example 4

In order to even further improve the solubility of the gelatin gel particles during further processing, it is possible even during manufacture of the gelatin gel particles moreover to add to the gelatin solution arising in the initial stage a sugar component, for example sugar, which is then dissolved in the solution and distributed in a molecularly disperse manner. The gel particles manufactured from this are, like the gel particles comprising only gelatin and water, mixed with sugar, glucose syrup etc., in order to produce from this a stable dispersion.

### Recipe Example

In a ca. 30 wt. % gelatin solution that arises as an intermediate product in gelatin production sugar is dissolved so that the solution has the following composition:

| | |
|---|---|
| water | 54 wt. % |
| gelatin (DS) | 23 wt. % |
| sugar | 23 wt. % |

Then the solution is cooled and gelled (as in the normal processing of gelatin) and the gel particles produced therefrom are mixed with sugar and glucose syrup to produce a dispersion according to the invention that has for example the following composition:

| | | |
|---|---|---|
| gelatin (DS) | 11.7 wt. % | |
| sugar | 26.6 wt. % | |
| glucose syrup | 24.0 wt. % | (78% DS) |
| the remainder | water | |

The sugar content of 26.6 wt. % is composed of 13.3 wt. % sugar contained in the gelatin gel particles and 13.3 wt. % sugar added as dry substance in pure form.

The viscosity of this composition according to the invention is 3,000 cP. The aw value achieved is 0.961.

### Example 5

### Gelatin Hydrolysate Composition A

| | |
|---|---|
| 37.5 wt. % | gelatin hydrolysate (dry substance) |
| | mean molecular weight = 3000 Da |
| 25.0 wt. % | Nutriose (95 wt. % dry substance) |
| the remainder | water |

In such a composition a fraction of the gelatin hydrolysate is present in dissolved form and a further fraction in solid, dispersed form.

The resulting aw value is 0.935. At 20° C. the viscosity is ca. 24,570 cP.

### Example 6

### Gelatin Hydrolysate Composition B

To the composition of Example 5 further fractions of the gelatin hydrolysate were added in powder form, resulting in the following composition:

| | |
|---|---|
| 43.3 wt. % | gelatin hydrolysate (dry substance) |
| | mean molecular weight = 3000 Da |
| 22.2 wt. % | Nutriose (95 wt. % dry substance) |
| the remainder | water |

The resulting aw value is 0.920. At 20° C. the viscosity is ca. 68,800 cP.

Although the composition according to the invention described in this example has a much higher viscosity than the one previously recommended as preferred, such compositions are free-flowing and may be pumped and dosed using conventional food technology equipment.

1. A free-flowing gelatin composition, comprising an aqueous liquid, gelatin gel particles dispersed therein and/or gelatin hydrolysate dissolved therein and one or more sugar components, wherein the sum of the contents of gelatin, gelatin hydrolysate and sugar component(s) is selected such that the composition has a water activity (aw value) of less than or equal to 0.97.

2. The composition according to claim 1, wherein the water activity (aw value) is 0.93 or less.

3. The composition according to claim 1, having a gelatin gel particle (dry mass) content of 20 to 40 wt. %.

4. The composition according to claim 1, wherein the sugar component(s) comprise one or more saccharides, wherein the saccharide content is 30 wt. % or more.

5. The composition according to claim 1, wherein the gelatin gel particles in a swollen state have a mean particle size of about 0.01 to about 3 mm.

6. The composition according to claim 1, wherein the gelatin hydrolysate content is 20 to 60 wt. %.

7. The composition according to claim 6, wherein the gelatin hydrolysate has a mean molecular weight of about 1,000 to about 20,000 Da.

8. The composition according to claim 6, wherein the sugar component(s) comprise one or more saccharides, wherein the saccharide content is 10 wt. % or more.

9. The composition according to claim 4, wherein the saccharide is selected from mono-, di- and/or oligosaccharides.

10. The composition according to claim 1, wherein the sugar component(s) comprise one or more alditols.

11. The composition according to claim 1, wherein the composition comprises a fraction of one or more edible acids.

12. The composition according to claim 11, wherein the composition has a pH value of lower than 5.

13. The composition according to claim 12, wherein the pH value of the composition is about 3 to about 4.5.

14. The composition according to claim 1, having a viscosity of at most 30,000 cP.

15. A food precursor comprising the composition of claim 1.

16. (canceled)

17. The food precursor according to claim 15, wherein the composition has an aw value of 0.93 or less.

18. The food precursor according to claim 15, having a gelatin gel particle (dry mass) content of 20 to 40 wt. %.

19. The food precursor according to claim 15, wherein the sugar component(s) comprise one or more saccharides, wherein the saccharide content is 30 wt. % or more.

20. The food precursor according to claim 15, wherein the gelatin gel particles in a swollen state have a mean particle size of about 0.01 to 3 mm.

21. The food composition according to claim 1, wherein the gelatin gel particles in a swollen state have a mean particle size of about 0.1 to 1 mm.
